(19) United States
(12) Patent Application Publication
(10) Pub. No.: US 2011/0157043 A1
(43) Pub. Date: Jun. 30, 2011

(54) ACTIVE DEVICE ARRAY SUBSTRATE AND TOUCH DISPLAY PANEL

(75) Inventors: Chih-Chang Lai, Taichung County (TW); Ting-Yu Chang, Kaohsiung County (TW); Po-Hsien Wang, Taichung City (TW); Ching-Fu Hsu, Taichung County (TW); Hsiao-Hui Liao, Taichung City (TW)

(73) Assignees: DONGGUAN MASSTOP LIQUID CRYSTAL DISPLAY CO., LTD., Guangdong Province (CN); WINTEK CORPORATION, Taichung (TW)

(21) Appl. No.: 12/962,668

(22) Filed: Dec. 8, 2010

(30) Foreign Application Priority Data
Dec. 29, 2009 (TW) 98145635

(51) Int. Cl. G06F 3/041

(52) U.S. Cl. 345/173

(57) ABSTRACT

An active device array substrate including an active device array and a plurality of touch sensing electrodes is provided. The active device array is disposed on a substrate. The touch sensing electrodes are disposed on the substrate, and the active device array and the touch sensing electrodes are insulated with each other so as to form a sensing capacitance between the active device array and the touch sensing electrodes.

### CROSS-REFERENCE TO RELATED APPLICATION

This application claims the priority benefit of Taiwan application serial no. 98145635, filed on Dec. 29, 2009. The entirety of the above-mentioned patent application is hereby incorporated by reference herein and made a part of this specification.

### BACKGROUND

1. Field of the Invention

The invention relates to an active device array substrate and a touch display panel. More particularly, the invention relates to an active device array substrate with a simple structure and fabrication process, and a touch display panel having the same.

2. Description of Related Art

With booming development of electronic technology, and popularisation of wireless communications and networks, various electronic devices gradually become indispensable tools in people's daily life. However, a commonly used input/output (I/O) interface such as a keyboard or a mouse has a certain degree of operational difficulty. Comparatively, a touch panel is an intuitive and simple I/O interface. Therefore, the touch panel is generally used as a communication interface between a user and an electronic device to perform control.

Generally, the touch panels can be grouped into resistive touch panels, capacitive touch panels, optical touch panels, and acoustic touch panels, etc. A development trend of the electronic products is to integrate the touch panel with a display panel. Taking a commonly used resistive touch panel or a capacitive touch panel as an example, a design of the touch panel is to use two layers of electrode layers to perform scanning and sensing operations. Therefore, to integrate the touch panel to the display panel, at least two electrode layers are additionally fabricated on the display panel, which may complicate a fabrication process.

Moreover, the display panel is generally formed by two substrates. The two layers of electrode layers used for touch control have to be fabricated onto a substrate closed to the user for providing a good touch sensing effect. However, such design may increase a thickness of the display panel. Moreover, in the display panel, a control circuit is generally fabricated on another substrate apart from the user. Therefore, to integrate the touch panel to the display panel, additional conductive connection elements (for example, conductive spacers) have to be used to connect the two layers of electrode layers used for touch control to the control circuit on the other substrate. Therefore, such design may further complicate the fabrication process of the touch display panel.

### SUMMARY OF THE INVENTION

The invention is directed to an active device array substrate, in which a sensing capacitance between an active device array and touch sensing electrodes may provide a touch sensing utilization.

The invention is directed to a touch display panel, which may have a touch sensing function and a display function under a simple fabrication process and structure design.

The invention provides an active device array substrate including an active device array and a plurality of touch sensing electrodes. The active device array is disposed on a substrate. The touch sensing electrodes are disposed on the substrate, and the touch sensing electrodes are insulated to the active device array, so as to form a sensing capacitance between the touch sensing electrodes and the active device array.

The invention provides a touch display panel including an active device array substrate, a counter substrate and a display medium layer. The active device array substrate includes an active device array and a plurality of touch sensing electrodes. The active device array is disposed on a substrate. The touch sensing electrodes are disposed on the substrate, and the touch sensing electrodes are insulated to the active device array, so as to form a sensing capacitance between the touch sensing electrodes and the active device array. The counter substrate has a counter electrode layer, and the display medium layer is located between the active device array and the counter electrode layer.

According to the above descriptions, the touch sensing electrodes are disposed on the active device array substrate and the active device array substrate is disposed at a side closed to a user. The touch display panel of the invention can achieve a touch sensing function and a display function without guiding touch sensing signals to another substrate through a conductive device. Therefore, the touch display panel and the active device array substrate of the invention have advantages of simple fabrication process and simple structure. Moreover, scan lines in the active device array can simultaneously serve as scan lines of a touch sensing operation, so as to further simplify a design of a touch sensing device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a touch display panel according to an embodiment of the invention.

FIG. 2 is a cross-sectional view of a touch display panel according to another embodiment of the invention.

FIG. 3 is a top view of an active device array substrate according to an embodiment of the invention, in which only touch sensing electrodes and an active device array are illustrated.

FIG. 4 is a diagram illustrating an active device array substrate according to another embodiment of the invention, in which only touch sensing electrodes, scan lines and data lines are illustrated.

FIG. 5 is a diagram illustrating an active device array substrate according to still another embodiment of the invention, in which only touch sensing electrodes, scan lines and data lines are illustrated.

### DETAILED DESCRIPTION OF DISCLOSED EMBODIMENTS

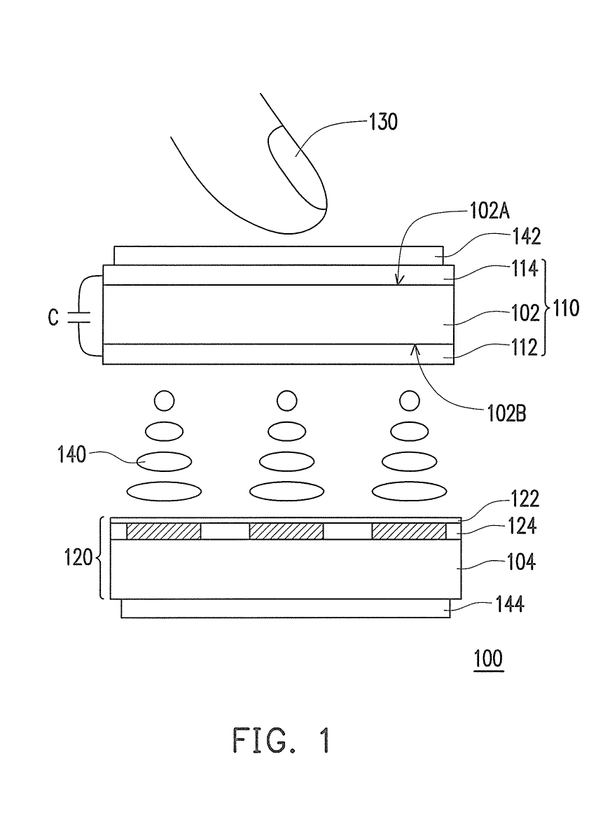

FIG. 1 is a cross-sectional view of a touch display panel according to an embodiment of the invention. Referring to FIG. 1, the touch display panel 100 includes an active device array substrate 110, a counter substrate 120, and a display medium layer 140.

The active device array substrate 110 includes a first substrate 102, an active device array 112, and a plurality of touch sensing electrodes 114 are respectively disposed at two sides of the first substrate 102, and a sensing capacitance C is formed between the touch sensing electrodes 114 and the active device array 112.

The counter substrate 120 includes a second substrate 104. A counter electrode layer 122 is disposed on a surface of the substrate 104. The display medium layer 140 is located between the active device array 112 and the counter electrode layer 122.

When a conductor object 130 approaches the first substrate 102, the conductor object 130 and the touch sensing electrodes 114 may form another capacitor, so that the sensing capacitance C is fluctuated. The touch display panel 100 may estimate a position of the conductor object 130 according to such fluctuating, so as to achieve both of a touch sensing function and a display function of the touch display panel 100. Herein, the conductor object 130 can be a user's finger, a metal piece, or a special stylus, etc.

The first substrate 102 is a transparent substrate, and the first substrate 102 has a display side 102A and a device side 102B opposite to the display side 102A, wherein the device side 102B is closed to the display medium layer 140. The active device array 112 is disposed at the device side 102B, and the touch sensing electrodes 114 are disposed at the display side 102A. A material of the display medium layer 140 can be a liquid crystal material, a plasma material, an organic light emitting diode, or an electrophoresis material. As shown in FIG. 1, when the material of the display medium layer 140 is the liquid crystal material, an upper polarizer 142 and a lower polarizer 144 are selectively attached to outer surfaces of the touch display panel 100.

The touch display panel 100 further includes a color filter layer 124, and the color filter layer 124 is disposed on the counter substrate 120, though in other embodiments, the color filter layer 124 can also be disposed on the active device array substrate 110.

Besides the devices required for displaying, only one layer of an electrode layer is additionally configured to the touch display panel 100 to form the touch sensing electrodes 114 to achieve both of the touch sensing function and the display function.

Accordingly, a design requirement of slimness is matched, and devices used for touch sensing are unnecessary to be electrically connected to another substrate though other conductive devices, such as conductive spacers, ACF (anisotropic conductive film), or the like. Therefore, a fabrication process of the touch display panel 100 is relatively easy, and a structure thereof is simple.

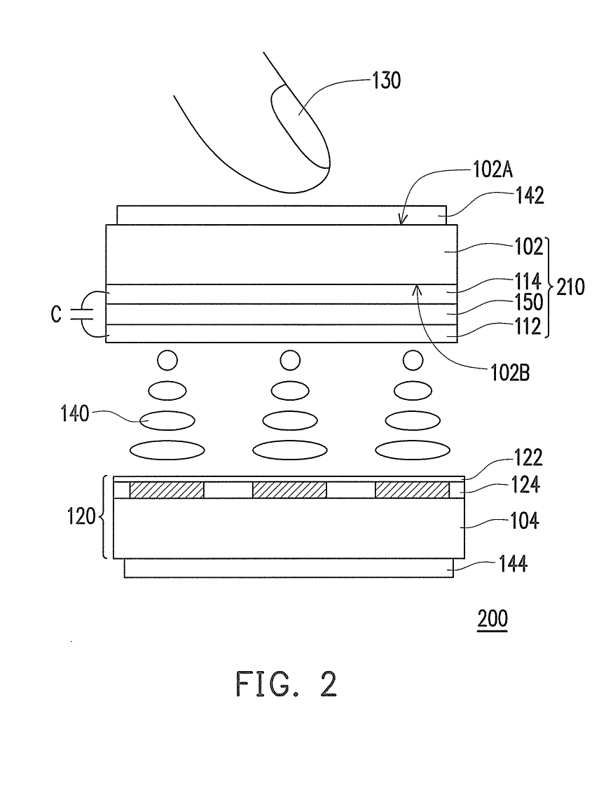

FIG. 2 is a cross-sectional view of a touch display panel according to another embodiment of the invention. Referring to FIG. 2, the touch display panel 200 substantially has all of the components of the touch display panel 100, though a design of the active device array substrate 210 is different therefrom. In the active device array substrate 210, the touch sensing electrodes 114, an insulation layer 150, and the active device array 112 are sequentially disposed at the device side 102B of the first substrate 102.

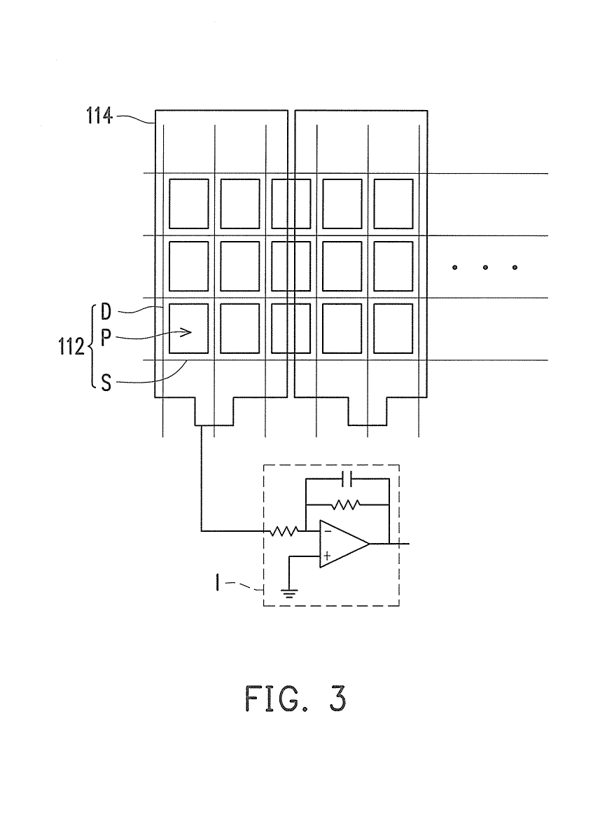

Structure designs and relationships of the active device array 112 and the touch sensing electrodes 114 of FIG. 1 and FIG. 2 are described in detail below. FIG. 3 is a top view of an active device array substrate according to an embodiment of the invention, in which only the touch sensing electrodes and the active device array are illustrated. Referring to FIG. 3, the active device array 112 includes a plurality of scan lines S, a plurality of data lines D, and a plurality of pixel structures P. Each pixel structure P is electrically connected to one of the scan lines S and one of the data lines D, and the scan lines S are not parallel to the data lines D. Moreover, each of the touch sensing electrodes 114 is a strip pattern electrode, and stretches across the scan lines S.

When the active device array 112 is fabricated, the scan lines S are first fabricated on the substrate. Therefore, according to FIG. 1 and FIG. 2, it is known that in the touch display panels 100 and 200, the scan lines S are devices in the active device array 112 that are closest to the touch sensing electrodes 114. When the active device array 112 starts to operate, the scan lines S gradually perform the scanning so that signals in the data lines D are transmitted to the corresponding pixel structures P. Herein, a scan signal of the scan line S can also serve as a scan signal of touch sensing.

Moreover, the touch sensing electrodes 114 can be coupled to an integrator I, so as to calculate a position of the conductor objector 130 according to a variation of the sensing capacitance C. Certainly, the number of the integrator I can be plural, and each integrator I is connected to one of the touch sensing electrodes 114 for calculation, so that the touch sensing electrodes 114 may synchronously perform the touch sensing.

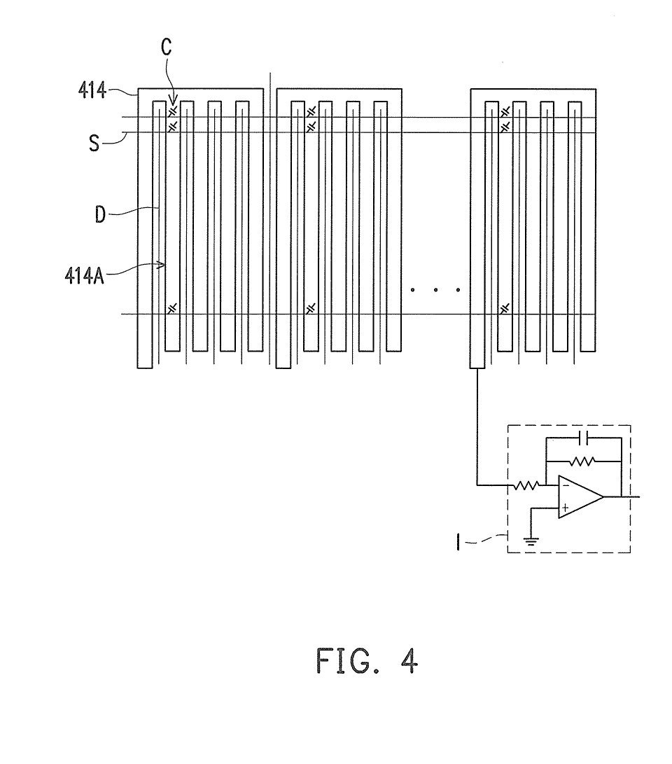

FIG. 4 is a diagram illustrating an active device array substrate according to another embodiment of the invention, in which only the touch sensing electrodes, the scan lines and the data lines are illustrated. In the present embodiment, each of the touch sensing electrodes 414 stretches across a plurality of the data lines D. To reduce an interference of the touch sensing signal caused by the data line D, each touch sensing electrode 414 has a plurality of openings 414A, and each opening 414A exposes one of the data lines D, so as to increase a touch sensing sensitivity.

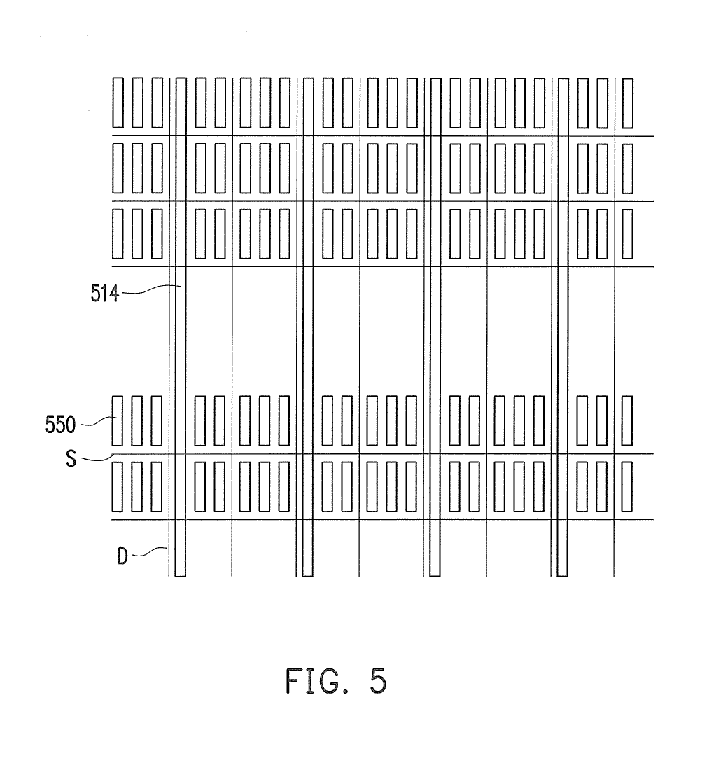

FIG. 5 is a diagram illustrating an active device array substrate according to still another embodiment of the invention. Referring to FIG. 5, compared to the aforementioned embodiments, touch sensing electrodes 514 are electrode patterns having a relatively narrow line width, and the touch sensing electrodes 514 are not overlapped with the data lines D, so that signals transmitted by the data liens D are not liable to influence the touch sensing signals. Furthermore, a plurality of dummy electrodes 550 and the touch sensing electrodes 514 are formed by a same film layer, and the dummy electrodes 550 are disposed between two adjacent touch sensing electrodes 514. By using the dummy electrodes 550, mutual interference of the signals in the touch sensing electrodes 514 can be reduced, and variation of the sensing capacitance can be increased, so as to increase correctness of the touch sensing.

In summary, in the invention, the touch sensing electrodes and the active device array are disposed on the same substrate. The scan lines in the active device array can serve as scan lines for touch sensing. Therefore, besides the devices of a generally display panel, only a layer of sensing electrodes is additionally configured to the touch display panel of the invention, so that a fabrication process of the touch display panel is greatly simplified. Moreover, the touch sensing electrodes of the invention may have a specific pattern design (for example, openings) to reduce the interference of the touch sensing signals caused by other conductor devices in the active device array. According to the invention, the dummy electrodes can be used to improve a sensing sensitivity of the touch sensing electrodes.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A an active device array substrate, comprising:
a substrate;
an active device array, disposed on a surface of the substrate; and
a plurality of touch sensing electrodes, disposed on the surface of the substrate, wherein the touch sensing electrodes are insulated to the active device array, so as to form a sensing capacitance between the touch sensing electrodes and the active device array.

2. The active device array substrate as claimed in claim 1, wherein the active device array comprises a plurality of scan lines, a plurality of data lines and a plurality of pixel structures, each of the pixel structures is electrically connected to one of the scan lines and one of the data lines, and the scan lines are not parallel to the data lines.

3. The active device array substrate as claimed in claim 2, wherein each of the touch sensing electrodes stretches across the scan lines.

4. The active device array substrate as claimed in claim 1, wherein the substrate has a display side and a device side opposite to the display side, the active device array is disposed at the device side, and the touch sensing electrodes are disposed at the display side.

5. The active device array substrate as claimed in claim 1, wherein the substrate has a display side and a device side opposite to the display side, and the touch sensing electrodes, an insulation layer and the active device array are sequentially disposed at the device side.

6. The active device array substrate as claimed in claim 1, wherein each of the touch sensing electrodes stretches across a plurality of the data lines.

7. The active device array substrate as claimed in claim 6, wherein each of the touch sensing electrodes has a plurality of openings, and each opening exposes one of the data lines.

8. The active device array substrate as claimed in claim 1, further comprising a plurality of dummy electrodes, wherein the dummy electrodes and the touch sensing electrodes are formed by a same film layer, and the dummy electrodes are disposed between two adjacent touch sensing electrodes.

9. A touch display panel, comprising:
an active device array substrate, comprising:
an active device array, disposed on a substrate;
a plurality of touch sensing electrodes, disposed on the substrate, wherein the touch sensing electrodes are insulated to the active device array, so as to form a sensing capacitance between the touch sensing electrodes and the active device array;
a counter substrate, having a counter electrode layer; and
a display medium layer, located between the active device array and the counter electrode layer.

10. The touch display panel as claimed in claim 9, wherein the active device array comprises a plurality of scan lines, a plurality of data lines and a plurality of pixel structures, each of the pixel structures is electrically connected to one of the scan lines and one of the data lines, the scan lines are not parallel to the data lines, and the substrate is a transparent substrate.

11. The touch display panel as claimed in claim 10, wherein each of the touch sensing electrodes stretches across the scan lines.

12. The touch display panel as claimed in claim 9, wherein the substrate has a display side and a device side opposite to the display side, the active device array is disposed at the device side, and the touch sensing electrodes are disposed at the display side.

13. The touch display panel as claimed in claim 9, wherein the substrate has a display side and a device side opposite to the display side, and the touch sensing electrodes, an insulation layer and the active device array are sequentially disposed at the device side.

14. The touch display panel as claimed in claim 9, wherein each of the touch sensing electrodes stretches across a plurality of the data lines.

15. The touch display panel as claimed in claim 14, wherein each of the touch sensing electrodes has a plurality of openings, and each opening exposes one of the data lines.

16. The touch display panel as claimed in claim 9, wherein the active device array substrate further comprises a plurality of dummy electrodes, wherein the dummy electrodes and the touch sensing electrodes are formed by a same film layer, and the dummy electrodes are disposed between two adjacent touch sensing electrodes.

17. The touch display panel as claimed in claim 9, further comprising an integrator electrically connected to the touch sensing electrodes, for calculating a position of a conductor object according to a variation of the sensing capacitance.

18. The touch display panel as claimed in claim 9, further comprising a color filter layer disposed on the active device array substrate or the counter substrate.

19. The touch display panel as claimed in claim 9, wherein a material of the display medium layer is a liquid crystal material, a plasma material, an organic light emitting diode, or an electrophoresis material.
